(19) United States
(12) Patent Application Publication
(10) Pub. No.: US 2021/0384620 A1
(43) Pub. Date: Dec. 9, 2021

(54) ANTENNA ASSEMBLY HAVING A COVER AND ELECTRONIC SYSTEM USING SAME

(71) Applicant: HON HAI PRECISION INDUSTRY CO., LTD., New Taipei (TW)

(72) Inventor: HUNG-CHIA CHANG, New Taipei (TW)

(21) Appl. No.: 16/985,548

(22) Filed: Aug. 5, 2020

(30) Foreign Application Priority Data
Jun. 5, 2020 (CN) 202010505512.9

(51) Int. Cl. H01Q 1/40; H01Q 1/24; H01Q 3/26; H01Q 21/29; H01Q 1/00

(52) U.S. Cl. CPC H01Q 1/40; H01Q 1/241; H01Q 1/002; H01Q 21/293; H01Q 3/2617

(57) ABSTRACT

A high-data-rate antenna assembly includes at least one radiating module and a radio frequency module. The at least one radiating module connected to an electronic device is configured to receive or transmit wireless signals. The radio frequency module is electrically connected to the at least one radiating module and processes the wireless signals. The electronic device transmits or exchanges the processed wireless signals with an external device through the at least one radiating module.

### FIELD

The subject matter herein generally relates to antenna assemblies.

### BACKGROUND

MIMO (multiple input multiple output) technology in networks has gradually become a popular and efficient communication technology. For example, most electronic devices, such as mobile phones, are equipped with MIMO antennas for higher efficiency, capacity, and higher quality data transmission. The installation of MIMO antennas in a limited space is problematic.

Therefore, there is room for improvement within the art.

### BRIEF DESCRIPTION OF THE DRAWINGS

Implementations of the present disclosure will now be described, by way of embodiment, with reference to the attached figures.

FIG. 1 is an isometric view of an embodiment of an electronic system including an antenna assembly and an electronic device.

FIG. 2 is an isometric view of radiating modules of the antenna assembly of FIG. 1.

FIG. 3 is a scattering parameter graph of the antenna assembly of FIG. 1.

FIG. 4 is an inserting loss graph of between different antenna modules of the antenna assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series, and the like.

The present disclosure is described in relation to an antenna assembly and an electronic system including the antenna assembly and an electronic device.

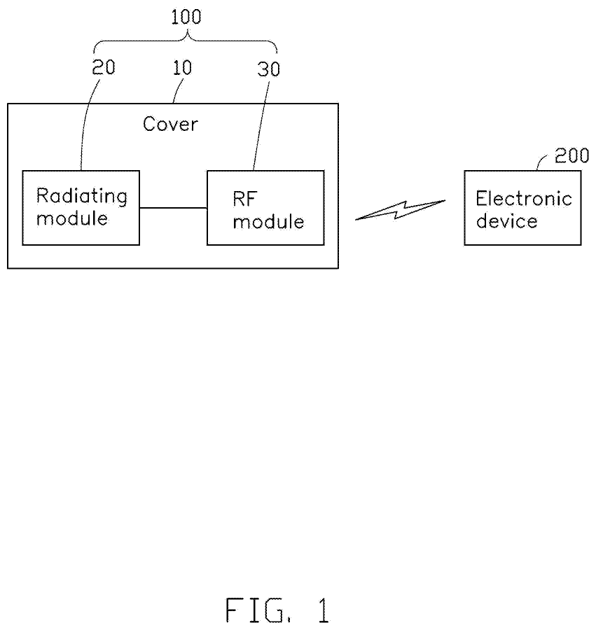

FIG. 1 illustrates an isometric view of an embodiment of an electronic system including an antenna assembly 100 and an electronic device 200. The antenna assembly 100 is connected to the electronic device 200. The antenna assembly 100 serves as an antenna module of the electronic device 200. Thus, the electronic device 200 can transmit and receive wireless signals through the antenna assembly 100, thereby communicating with an external device (not shown).

In this embodiment, the electronic device 200 can be a terminal device, or a mobile device such as a smart phone, a tablet computer, a notebook computer, or a desktop computer. In this embodiment, the external device is a base station.

In this embodiment, the antenna assembly 100 includes a cover 10, at least one radiating module 20, and an RF (radio frequency) module 30. The cover 10 is configured to receive the at least one radiating module 20 and the RF module 30.

In this embodiment, the cover 10 can be a shell or a protective cover, such as a mobile phone shell or a mobile phone case. The antenna assembly 100 is positioned independently from the cover 10, and communicatively connected to the electronic device 200.

In other embodiments, the cover 10 can be detachably assembled to the electronic device 200 and thereby protecting the electronic device 200. That is, the size, and shape of the cover 10 are matched with those of the electronic device 200. Thus, the antenna assembly 100 can be detachably assembled to a back cover of the electronic device 200 and cover the electronic device 200, thereby protecting the electronic device 200. The cover 10 can also be set independently from the electronic device 200.

In this embodiment, when the cover 10 serves as a protective cover of the electronic device 200, the cover 10 also serves as a carrier of the at least one radiating module 20. By arranging the at least one radiating module 20 inside the cover 10, the number of the radiating modules 20 can be increased, thereby increasing a data transmitting rate of the antenna assembly 100. In addition, the space inside the electronic device 200 occupied by the at least one radiating module 20 can be saved to install other electronic components.

In this embodiment, the at least one radiating module 20 is positioned inside the cover 10. The at least one radiating module 20 receives the wireless signals transmitted out by the base station and also receives incoming wireless signals to the base station. Thus, the communication between the base station and the electronic device 200 can be realized.

In other embodiments, the at least one radiating module 20 is positioned inside the cover 10 adjacent to a side of the electronic device 200.

In this embodiment, the at least one radiating module 20 is arranged as N rows of the radiating modules 20 and M columns of the radiating modules 20, forming an antenna array. N and M are positive integers, and the numbers of N and M can be equal or unequal.

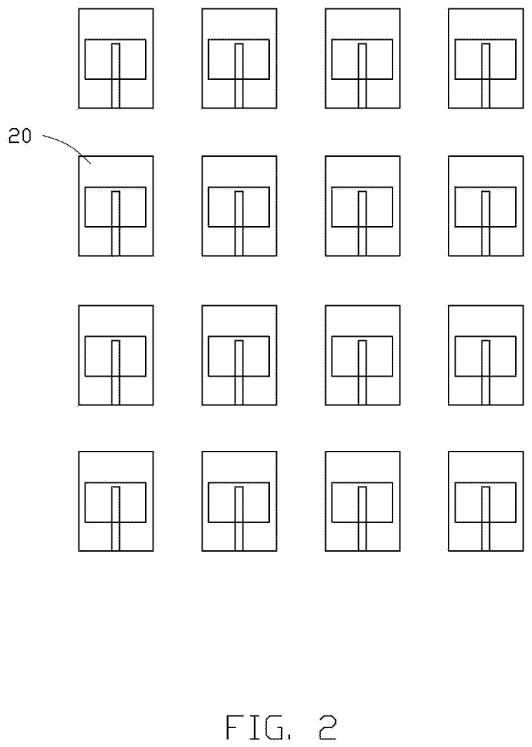

FIG. 2 illustrates an isometric view of the radiating modules 20 of the antenna assembly 100. In this embodiment, N and M are both four in number. That is, the radiating modules 20 form a 4*4 antenna array, and the number of the radiating modules 20 is sixteen. In an embodiment, the overall size of the 4*4 antenna array formed by the radiating modules 20 is about 11 cm*7 cm.

In other embodiments, the number of the radiating modules 20 is not limited to sixteen. The arrangement and number of the radiating modules 20 can be changed according to the shape and size of the cover 10. The number of the radiating modules 20 can be eight, ten, twelve, or other number.

In this embodiment, there may be different types of radiating modules 20, not being limited as herein.

In this embodiment, each radiating module 20 in the antenna array is a MIMO antenna. The antenna array uses the multiple MIMO antennas to cooperatively transmit and receive the wireless signals. Similarly, in this embodiment, by modifying the structure of the at least one radiating module 20, each radiating module 20 can form other antenna, for example, a 5G NR antenna, which can operate at a 5G NR frequency band. The 5G NR frequency band includes two frequency bands, these being an FR1 frequency band and an FR2 frequency band. The frequency range of the FR1 frequency band is about 450 MHz-6 GHz, also known as the sub 6 GHz band. The frequency range of the FR2 frequency band is 24.25 GHz-52.6 GHz, also called millimeter wave (mm wave).

In this embodiment, the RF module 30 is positioned inside the cover 10. The RF module 30 processes the outgoing and incoming wireless signals from or to the radiating module 20. Specifically, in this embodiment, the RF module 30 can include, but is not limited to, a filter, a switch, a power amplifier, a LNA (low noise amplifier), a modulation and demodulation processor, and the like.

In this embodiment, the electronic device 200 can provide electric power to the antenna assembly 100 during a process of transmitting and receiving the wireless signals. Thus, no additional power supply is needed for the antenna assembly 100.

As described above, when the electronic device 200 uses the antenna assembly 100 to transmit and receive the wireless signals, the at least one radiating module 20 and the RF module 30 are positioned inside the cover 10, the antenna assembly 100 is communicatively connected to the electronic device 200, and the electronic device 200 provides the electric power to the antenna assembly 100. Thus, when the electronic device 200 receives the wireless signals through the antenna assembly 100, the radiating module 20 receives wireless signals sent by the base station, and the RF module 30 processes (by filters, amplifiers, demodulators, and beamforming controls) the received wireless signals, and then transmits the processed wireless signals to the electronic device 200.

Similarly, when the electronic device 200 transmits wireless signals to the base station through the antenna assembly 100, the RF module 30 firstly processes the wireless signals, and then transmits the processed wireless signals to the base station via the radiating module 20.

In this embodiment, the antenna assembly 100 can communicate with the electronic device 200 by means of millimeter waves (the frequency range corresponding to the millimeter waves is about 30-300 GHz). In this embodiment, because the sixteen radiating modules 20 simultaneously communicate with the electronic device 200, in ideal conditions, 16¹⁶ times the number of transmitting channels (relative to a single radiating module 20) is required to transmit data. Thus, the communication between the antenna assembly 100 and the electronic device 200 is realized through the millimeter waves with a narrow beam and a wide bandwidth.

Specifically, in this embodiment, a millimeter waves antenna (not shown) can be positioned on the RF module 30, and the antenna assembly 100 communicates with the electronic device 200 by the means of millimeter waves through such antenna.

In this embodiment, the electronic device 200 which transmits and receives the wireless signals between itself and the base station through the antenna assembly 100 has a higher data transmission efficiency.

In this embodiment, when the at least one radiating module 20 forms the antenna array, a distance between adjacent radiating modules 20 can be adjusted according to the requirements. When the distance between the adjacent radiating modules 20 is large, the number of the radiating modules 20 which can be positioned in the cover 10 is less, and the data transmission efficiency is lower. When the distance between the adjacent radiating modules 20 is too close, interference can occur between the radiating modules 20, affecting the data transmission. Thus, provided interference is not generated, as many radiating modules 20 as possible can be installed to achieve the higher data transmission efficiency.

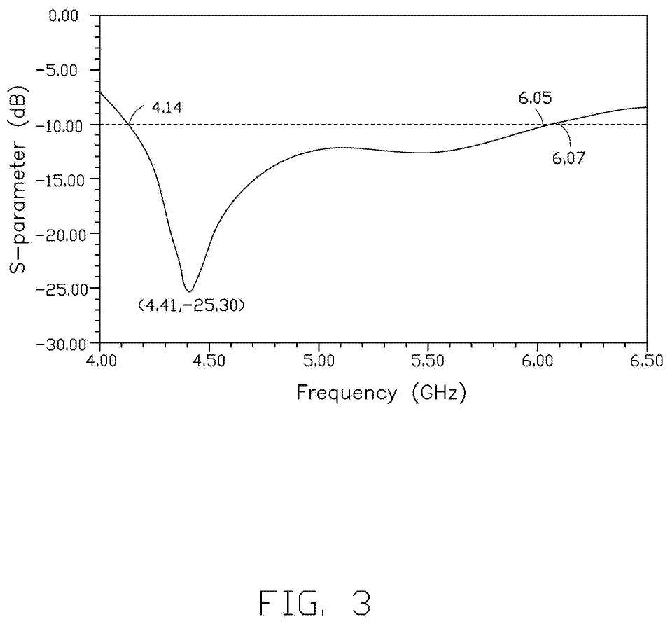

FIG. 3 shows a scattering parameter of each radiating module 20 of the antenna assembly 100 at different frequency bands. In one of the frequency bands, such as a frequency band of 4.14 to 6.05 GHz, the scattering parameter of each radiating module 20 is lower than −10 dB, which satisfies the purpose of the antenna, and at a frequency of 4.41 GHz, the scattering parameter of each radiating module 20 is the lowest. Thus, the radiating module 20 can support data transmission at the frequency bands of 4G or 5G and the antenna assembly 100 can operate at the FR1 frequency band of the 5G NR frequency band.

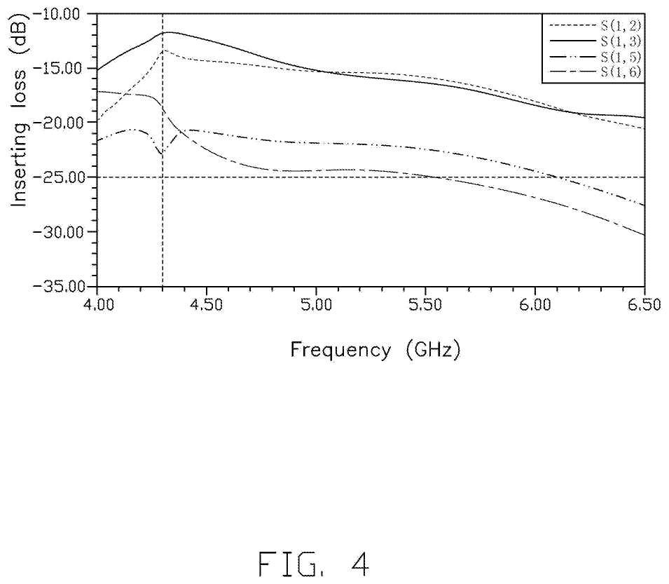

FIG. 4 is a graph showing inserting losses of the antenna assembly 100 with different numbers of the antenna assemblies 100. Curve S (1, 2) represents an actual gain of a first radiating module 20 and a second radiating module 20. Curve S (1, 5) represents an actual gain of the first radiating module 20 and a fifth radiating module 20. Curve S (1, 6) represents an actual gain of the first radiating module 20 and a sixth radiating module 20. To achieve their purpose, the inserting losses of the radiating modules 20 should be between 25 dB and −10 dB. As shown in FIG. 4, the inserting losses between different radiating modules 20 satisfy this requirement.

In addition, the greater the number of the radiating modules 20 is inserted into the antenna array, the smaller the inserting loss of the antenna assembly 100 is, and the higher the corresponding transmission efficiency of the antenna assembly 100 is. The electronic device 200 transmits and receives the wireless signals with the base station through the antenna assembly 100. The data transmission rate is related to the number of the radiating modules 20 provided in the cover 10. The greater the number of the radiating modules 20 is, the higher the data transmission rate is. Of course, the distance between the radiating modules 20 (i.e. isolation) is important. The better the isolation is, the smaller the interference between the radiating modules 20 is and the better the effectiveness of data transmission can be achieved.

In this embodiment, by independently arranging the antenna assembly 100 outside the electronic device 200, the number of the radiating modules 20 can be effectively increased, which not only saves the space of the electronic device 200, but also further improves the data transmission rate.

The embodiments shown and described above are only examples. Many details are often found in the art such as the other features of the antenna assembly and the wireless communication device. Therefore, many such details are neither shown nor described. Even though numerous characteristics and advantages of the present disclosure have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An antenna assembly comprising:
at least one radiating module configured to receive or transmit wireless signals and communicatively connected to an electronic device; and
a radio frequency module electrically connected to the at least one radiating module and configured to process the wireless signals; wherein the electronic device transmits or exchanges the processed wireless signals with an external device through the at least one radiating module.

2. The antenna assembly of claim 1, further comprising a cover, wherein the cover receives the at least one radiating module and the radio frequency module.

3. The antenna assembly of claim 1, wherein the at least one radiating module is a 5G NR antenna which operates at a corresponding 5G NR frequency band.

4. The antenna assembly of claim 1, wherein the at least one radiating module is a multiple input multiple output antenna.

5. The antenna assembly of claim 2, wherein the at least one radiating module is arranged as N rows of the radiating modules and M columns of the radiating modules to form a corresponding antenna array, wherein, N and M are positive integers.

6. The antenna assembly of claim 2, wherein the cover is detachably assembled to the electronic device.

7. The antenna assembly of claim 6, wherein the at least one radiating module is positioned inside the cover and at a side adjacent to the electronic device.

8. The antenna assembly of claim 1, wherein the electronic device further provides electric power to the antenna assembly.

9. The antenna assembly of claim 1, wherein the at least one radiating module communicates with the electronic device by a millimeter wave antenna.

10. The antenna assembly of claim 1, wherein the at least one radiating module is arranged as four rows of the radiating modules and four columns of the radiating modules to form a corresponding 4*4 antenna array.

11. An electronic system comprising:
an electronic device; and
an antenna assembly comprising:
at least one radiating module configured to receive or transmit wireless signals and communicatively connected to the electronic device; and
a radio frequency module electrically connected to the at least one radiating module and configured to process the wireless signals; wherein the electronic device transmits or exchanges the processed wireless signals with an external device through the at least one radiating module.

12. The electronic system of claim 11, wherein the antenna assembly further comprises a cover, the cover receives the at least one radiating module and the radio frequency module.

13. The electronic system of claim 11, wherein the at least one radiating module is a 5G NR antenna which operates at a corresponding 5G NR frequency band.

14. The electronic system of claim 11, wherein the at least one radiating module is a multiple input multiple output antenna.

15. The electronic system of claim 12, wherein the at least one radiating module is arranged as N rows of the radiating modules and M columns of the radiating modules to form a corresponding antenna array, wherein, N and M are positive integers.

16. The electronic system of claim 12, wherein the cover is detachably assembled to the electronic device.

17. The electronic system of claim 16, wherein the at least one radiating module is positioned inside the cover and at a side adjacent to the electronic device.

18. The electronic system of claim 11, wherein the electronic device further provides electric power to the antenna assembly.

19. The electronic system of claim 11, wherein the at least one radiating module communicates with the electronic device by a millimeter wave antenna.

20. The electronic system of claim 11, wherein the at least one radiating module is arranged as four rows of the radiating modules and four columns of the radiating modules to form a corresponding 4*4 antenna array.
